(19) United States
(12) Patent Application Publication
(10) Pub. No.: US 2015/0100370 A1
(43) Pub. Date: Apr. 9, 2015

(54) Method and System for Generating Supplier Capacity Requirements

(71) Applicant: Ford Global Technologies, LLC, Dearborn, MI (US)

(72) Inventors: Yakov M. Fradkin, Farmington Hills, MI (US); Gintaras Vincent Puskorius, Novi, MI (US); Ravindra Venkata Tappeta, Novi, MI (US)

(73) Assignee: Ford Global Technologies, LLC, Dearborn, MI (US)

(21) Appl. No.: 14/048,556

(22) Filed: Oct. 8, 2013

(51) Int. Cl. G06Q 10/06; G06Q 10/08

(52) U.S. Cl. CPC G06Q 10/06315; G06Q 10/0875
USPC 705/7.25

(57) ABSTRACT

One or more embodiments include a computer-implemented method or system for generating part volumes necessary to assemble all vehicles of a vehicle product line for a predetermined time period. The method or system being configured to receive a product definition representing valid configurations for a product. The products may include feature families with mutually exclusive features. The method or system also receives a feature forecast rate or sales forecast rate that may be an aggregated demand. The method or system may further receive a bill of material for the product. The method or system may generate a forecasted order that is a quantity of each configuration by interacting the feature forecast rate and the product definition. The method or system may further generate a part volume necessary to assemble the product by interacting the quantity of each configuration with a product bill of material.

### TECHNICAL FIELD

Embodiments of the present disclosure relate generally to methods and systems for generating a part volume necessary to assemble a product.

### BACKGROUND

U.S. Pat. No. 6,711,550 discloses a method and system for accurately forecasting the quantity of all parts necessary to assemble all vehicles of a vehicle product line for a predetermined time period. The method comprises inputting the available features and product rules for vehicle orders of the vehicle line into a computer data base, inputting sales forecasts for a first plurality of features of the vehicle line into the computer data base, randomly generating a substantial sample of vehicle orders based on the features, product rules, and the feature sales forecasts, and determining the quantity of all parts necessary to assemble all vehicles of a vehicle product line for a predetermined time period based on the sample order.

U.S. Pat. No. 6,032,125 discloses a method and a system for forecasting the demand agreeing with the fluctuation trend of sales results at high and stable precision, without requiring user's maintenance, by using a model optimum for grasping the fluctuation trend of sales results, even if the products are diverse, by storing a plurality of models of neural network, for example, a model for forecasting the demand from data of the past several months, a model for forecasting the demand from data of the same period of the previous year, and a model for forecasting the demand from both the latest data and data of the same period of the previous year, and also by feeding sales results into a model of neural network to make it learn by the short period such as by the week, and a recording medium in which is recorded such program.

In U.S. Pat. No. 6,470,324, a dealer inventory management system is provided for recommending which types of vehicles a dealer should order from the automotive manufacturer. The computer-implemented system includes a vehicle sales data structure for storing vehicle sales information, a dealer data structure for storing dealer information, and a vehicle availability data structure for storing which vehicles are available to each dealer. A market determination module accesses the vehicle sales and dealer data structures to determine an ideal sales mix of vehicles for each dealer based upon a sampling of vehicle sales made in the dealer's local market. A dealer assessment module then accesses the vehicle availability data structure to formulate a recommended order for each dealer by comparing the dealer's ideal sales mix to the mix of vehicles available to that dealer.

U.S. Pat. No. 7,827,053 discloses a method for tire market forecasting that combines three sub-methods to forecast unit volumes for every tire size in the industry or market segment. The method includes deriving a full trend by a first sub-method M1 for a first tire size TS1 based upon a relationship between OE and replacement markets for size TS1; deriving a full trend by a second sub-method M2 for size TS1 based on an estimated vehicle fleet for size TS1; and comparing the first and second full trends to derive a regular forecast. When a tire size does not follow a predictable pattern according to OE assumptions, a full trend is derived by a third sub-method M3 based on an historic replacement market trend adjusted as needed by statistical tools. A vitality calculation may be made calculating present and future vitality V on a market segment or on a selected tire line, and a vitality goal VG may be established whereupon a strategy may be derived identifying tire sizes required and not required to achieve and maintain the goal over time.

### SUMMARY

One or more embodiments include a computer-implemented method or system for generating part volumes necessary to assemble a product, the computer-implemented method or system being configured to receive a product definition representing valid configurations for a product. The products may include feature families with mutually exclusive features. The computer-implemented method or system also receives a feature forecast rate or sales forecast rate. The feature forecast rate or sales forecast rate may be an aggregated demand. The computer-implemented method or system may further receive a bill of material for the product. The computer-implemented method or system may generate a forecasted order that is a quantity of each configuration by interacting the feature forecast rate and the product definition. The computer-implemented method or system may further generate a part volume necessary to assemble the product by interacting the quantity of each configuration with a product bill of material.

### BRIEF DESCRIPTION OF THE DRAWINGS

FIG. 1 is a block topology of a system for product configuration validation;

FIG. 2 is a non-limiting flow diagram according to one embodiment;

FIG. 3 illustrates a non-limiting table according to one embodiment;

FIG. 4 illustrates another non-limiting table according to one embodiment;

FIG. 5 illustrates another non-limiting table according to one embodiment;

FIG. 6 illustrates another non-limiting table according to one embodiment; and

FIG. 7 illustrates another non-limiting table according to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Global capacity planning (GCP) is typically employed by a manufacturer to determine and secure a particular supplier's production capacity. For example, an automotive manufacturer typically assembles vehicles based upon end-item parts that it receives from third-party suppliers. Most major automobile manufacturers carry between ten to twenty lines of vehicles and sell on the order of hundreds of thousands of vehicles per year.

The parts necessary for each vehicle can vary significantly from vehicle to vehicle. To begin, each vehicle line may include more than one model (e.g., Ford Escape, Ford Escape SE, Ford Escape SEL, Ford Escape Limited). More specifically, for each vehicle line there is a plurality of features that a consumer may have when selecting their vehicle. A vehicle line may also have thousands of features, some of which may be customer-selectable features. For instance, a particular model may offer about a hundred customer choices available among standard and optional features that include heated seats, leather seats, transmission type, engine size (e.g., 4-cylinder, 6-cylinder, v-6), etc. As such, the manufacturing of any given vehicle line can require thousands of different vehicle parts.

Due to the complexity of an automotive vehicle, multiple suppliers may be sourced to provide parts as simple as windshield wipers to parts as complex as engine transmission control modules (e.g., ECM). To further increase the complexity, variations within a particular vehicle model may require different parts that may or may not be provided by the same supplier (e.g., Ford Mustang vehicle having a manual or automatic transmission). Lastly, the complexity may further be agitated by the fact that an automotive manufacturer operates multiple manufacturing facilities around the globe and requires a particular number of parts provided from a supplier at each facility.

Adding to the complicated process of manufacturing vehicles is that the vehicle manufacturer uses hundreds of different part suppliers to supply it with the parts required to manufacture the vehicles of a vehicle line. These suppliers may be locally or internationally located. In order for the parts suppliers to be able to provide the automobile manufacturer's assembly plants with the necessary parts at the necessary time, it is not uncommon for the parts supplier to require advanced notice (e.g., as long as three or more years) of the required parts and volumes needed. Primarily, this is because the parts supplier requires a great deal of time to design and construct the parts manufacturing facilities. Thus, to provide reasonable assurance of being able to meet an automobile manufacturer's future parts needs; part suppliers typically require accurate information from the automobile manufacturer about expected shipping volumes usually between one to three years in advance of the actual assembly of the finished vehicles.

The actual parts necessary for each vehicle may be determined, however, after a vehicle is ordered. The parts may be determined, in large part, from the features that the consumer selects for his vehicle. For instance, a vehicle order may be determined when a consumer selects some or all of the features desired for a particular vehicle. The automobile manufacturer may then use the vehicle order as a set of instructions to build or find a vehicle that fits the customer's selected order. A vehicle order may include a selection from each of a plurality of families represented on the order. A family typically may be a listing, or grouping, of all of the available selections with respect to a particular type of feature. For instance, typical families may include all of the countries a vehicle line is sold in, all of the models of a vehicle line for a particular country, air conditioning or no air conditioning, all of the engine types available for a vehicle model, etc. For an order to be complete, a selection must be made, either explicitly or implicitly, from each family. Essentially, each family on an order represents a selection that must be made to construct a vehicle.

In addition to comprising feature selections made by the vehicle consumer, a vehicle order may also include selections made by the vehicle manufacturer as a result of the customer selections. For instance, if the vehicle is being purchased for use in the U.S., the order indicates that the vehicle is a U.S. model vehicle. The country of use may also dictate inclusion in the vehicle of regulatory-type features that may include fuel type (leaded or unleaded), emission-related items (tailpipe and noise emissions), safety-related items (air bags), etc. For example, orders for non-commercial vehicles that are being purchased in the U.S. may require a particular set of safety features that are necessary to fulfill government regulations that are not required for a similar vehicle sold in China. As such, each previous selection on an order can affect the selections (i.e. families) that follow and different vehicle-models may be available in some but not all countries.

The features, pre-sorted in their families, may be the format the features are input into a database. Preferably, the families are arranged in the orders and in the database in the perceived optimal sequence for generating vehicle orders. This is done by sequencing the families according to how customers typically choose features while ordering a vehicle. The positioning of the first (initial) families in an order is typically decided by the sales department. These first families are deemed the “important families” of the orders—the families a customer would consider first in filling out his vehicle order, such as vehicle model, engine, etc.

While the consumer has many different features from which to choose, the consumer may also have limitations in the features he selects placed upon him by the product rules of the vehicle line. These product rules are received along with the features. The product rules typically include the physical relationships that exist between various features. These product rules come about from the physical relationships that a particular family has with other families. These relationships can indicate a requirement (i.e., by selecting a first feature, a second feature is automatically selected) or a restriction (i.e., by selecting a first feature, a second feature is automatically precluded). Essentially, the product rules may define which features a consumer may be able to choose by defining those features that he is not able to choose by virtue of selecting another feature (i.e., restrictions), and those that he typically may choose by virtue of selecting another feature (i.e., requirements). Thus, the product rules identify the available feature selections a consumer has available to him while filling out his order as dictated by one or more features that he previously selected on his order. For instance, a restriction may occur when a consumer picks a particular type of drive, such as two-wheel drive, often times he is not able to have certain suspensions.

A requirement may occur when the relationship is determined as being mandatory. An example is when the consumer picks air conditioning as a feature. The vehicle may then require a radiator that can handle the cooling requirements of the air conditioning feature. Thus, by picking “air conditioning”, the consumer is also picking a particular radiator type, whether or not the consumer knows or is aware of this requirement. The product rules might also dictate more complex mandatory combinations of features. For example, premium stereo might require premium speakers whenever the customer selects luxury trim. In this case, it is the selection of premium stereo with luxury trim (and not the selection of premium stereo alone) that dictates premium speakers (with non-luxury trim, the rules might permit selection of premium stereo with non-premium speakers). Essentially, a requirement is a mandatory feature combination that requires the implicit or explicit selection of a plurality of features by the explicit selection of at least one feature.

However, since the parts manufacturer needs advance notice of the parts and their quantities sometimes as much as one-two years in advance of production of the vehicles, and since customers do not wish to wait much longer than a week or so for their vehicle once ordered, it is typically not realistic to wait until the orders have been completed before alerting a parts manufacturer as to what parts are needed. Accordingly, an automotive manufacturer typically relies upon the sales department to “forecast,” potential parts necessary based on sales histories or intended promotions, the expected sales proportions of the individual features of a vehicle line. Any part used solely when a single feature is selected (e.g., a part that is used solely on all vehicles with air conditioners) would therefore get a reliable forecast by simply making the part forecast agree with the feature forecast.

Providing inaccurate information to the parts supplier can result in any number of problems. One problem, underestimating future demand, can result in lost sales for the automobile manufacturer because of insufficient capacity to supply parts needed for the assembly of vehicles. Another problem, resulting from overestimating demand is the loss associated with wasted facilities. Because of high volume frequently seen in the automotive industry, even the smallest miscalculation of future parts demand can translate into very large losses of capital to an automotive manufacturer.

Due to the potential miscalculations and complexity of automotive manufacturing, capacity planning is virtually required to ensure that the correct number and configuration of parts are provided to the correct manufacturing facility at the time specified by the automotive manufacturer. Any breakdown within the supplier chain due to ineffective capacity planning could result in a manufacturing facility becoming idle while waiting for the part to be provided by the requisite supplier. This, in turn, results in unfulfilled or incorrect vehicle orders and quite possibly lost sales. The present disclosure contemplates a method and system of producing credible capacity planning forecasts at the end-item part level months or even years ahead of manufacturing an actual product.

For instance, to avoid such inaccuracies, one potential Global Capacity Planning (GCP) system may forecast material requirements by “fusing” or calculating information from various sources. Such a GCP system may receive a product structure, a demand forecast and a bill of materials (BOM). Based on this information a GCP system may forecast a valid parts volume to ensure that the correct number of parts, in the correct quantity is delivered to the correct manufacturing facility at the requisite time. This may allow an automotive manufacturer the capability of determining the quantity and configurations of vehicles that may be ordered by future customers. An automotive manufacturer would therefore be capable of meeting customer demand for a product, while minimizing the potential for manufacturing disruptions and unnecessary or over-ordered parts.

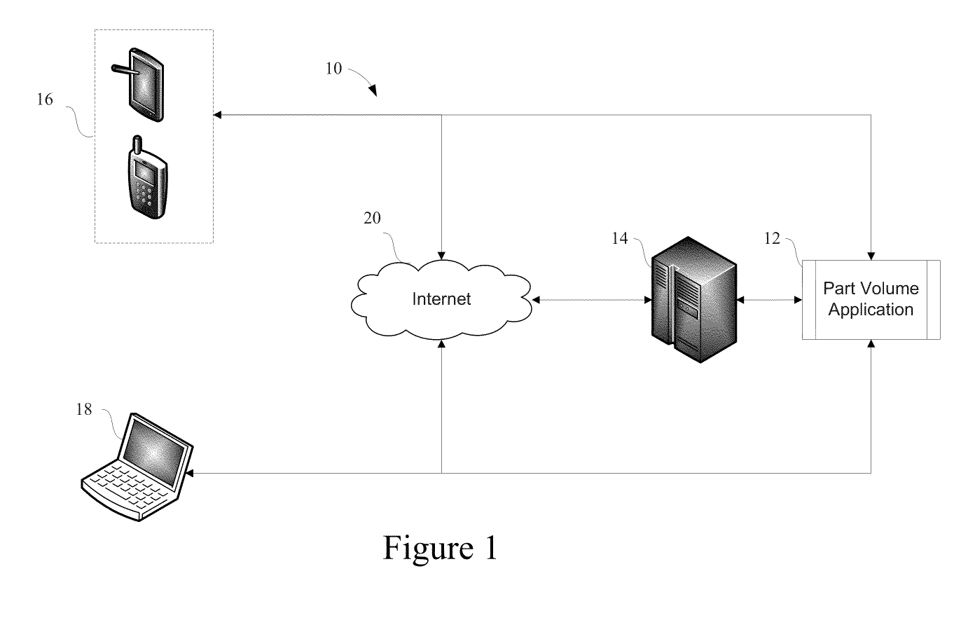

FIG. 1 illustrates a block topology of a system 10 for generating part volumes necessary to assemble a product in accordance with one non-limiting embodiment of the present invention. The part volume application 12 may be a client application that receives information from a database 14 or from user input devices 16, 18.

The application 12 may also be installed and executed from a client terminal, such as a personal computer 18 and/or a nomadic device 16 (e.g., a tablet, a mobile phone, and the like). The application 12 may be installed to the client device 16 or 18 from a computer-readable storage medium such as (and without limitation) a CD-ROM, DVD or USB thumb drive. Alternatively, the application may be downloaded from database 14 to the personal computer and/or nomadic device 16, 18 via an internet connection 20. The design and efficiency of the application 12 therefore allows it to be optimized to run on multiple various operating system platforms and on devices having varying levels of processing capability and memory storage.

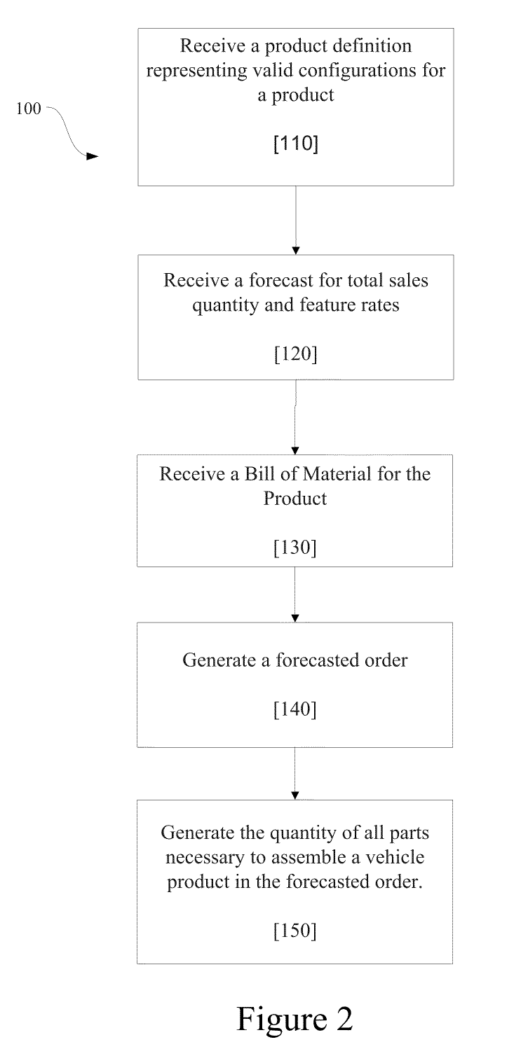

FIG. 2 illustrates an exemplary flow-diagram 100 of the part volume application 12 that is used to generate or forecast part volumes necessary to assemble a product such as an automotive vehicle. The present disclosure contemplates that the flow diagram illustrated in FIG. 2 is one non-limiting example and the steps may be performed in an order other than what is shown or the flow diagram may include more or fewer steps than shown. Various steps or functions, or groups of steps or functions, may be repeatedly performed although not explicitly illustrated.

To begin, step 110 illustrates the application 12 receiving a product definition representing valid configurations for a product, wherein the products include feature families with mutually exclusive features. The present disclosure further contemplates that the product definition may be a pre-processed set of product rules. The product definition may be stored on database 14, or the like. Alternatively, the product configurations may be stored in personal computer and/or nomadic device 16, 18. The application 12 may receive the product definition via wired or wireless internet connection 20 or through wired or wireless network connections.

The present disclosure contemplates that the product definition may be presented as uncompressed configurations where the number of configurations may be in the billions (i.e., N_{config}≈billions). Using uncompressed configurations, the buildable space would typically need to be sampled and heuristics may also be required during processing.

The present disclosure also contemplates that the product rules may be transformed from local rule set to a global representation that can be used for the necessary materials forecasting process. More specifically, the present disclosure contemplates that the product rules may be transformed to one or more super-configuration matrices as disclosed in U.S. patent application Ser. No. 13/268,276 which is incorporated herein by reference in its entirety. Such a super-configuration matrix may be a complete representation of one or more local product definition rules that have been transformed and condensed into a global representation. Such a compression may reduce the number of configurable product rules down to a fraction of the configurable product rules used by the uncompressed configuration (i.e., N_{config}≈thousands). By using the super-configuration matrix of a product definition, the present disclosure is capable of calculating part-level material requirements. Such a compact product rule set may also be used by other entities within an automotive manufacturer aside from GCP.

The present disclosure contemplates that using the super-configuration matrices, the universe of buildable configurations may already be compressed into the super-configuration matrix shown in Equation (1) below.

S={sₖⱼᵢ in {0,1}} (1)

Wherein k is the super-configuration index; j is the feature family; and i is the feature within the family j.

Once the product configuration is received, flow diagram 100 proceeds to step 120 where application 12 may receive a forecast for total sales quantity and feature rates where the feature forecast rate may be an aggregated demand. The present disclosure also contemplates that an automotive marketing organization may be capable of forecasting with reasonable accuracy the total demand (V) and the demand for many individual features and combinations of features. For instance, the present disclosure contemplates that the demand may be limited by providing upper and lower thresholds (i.e., τⱼᵢ^{l} and τⱼᵢ^{u}) for the feature rates. Flow Diagram 100 then proceeds to step 130 where application may receive a bill of material (BOM) for the product.

The present disclosure contemplates that a BOM may be a relationship between the features selected on an order and the parts required to manufacture the vehicle pursuant to the order. The BOM may also identify which part, or parts, are needed to satisfy each particular usage condition. A usage condition is a feature or a combination of features. An example of a usage condition would be, if the vehicle order indicates that the vehicle is to have air conditioning and a stereo with a CD-player, then the instrument panel for the vehicle must be part X. The manufacturer would then require the instrument panel identified as part X for that vehicle for installation in the vehicle. Therefore, the generated orders are used in the process of calculating part quantities.

Flow diagram 100 then proceeds to step 140 where application 12 generates a forecasted order specifying the quantity of each feature in each configuration of the product by interacting the feature forecast rate with the product definition. Stated differently, application 12 may be used to generate or determine the set of configuration feature quantities that best fit a desired forecast while obeying the product structure.

For uncompressed configurations, the present disclosure contemplates that generating a quantity of each configuration (i.e., a forecasted order) may be calculated using the following equation:

$$min {\sum }_{k = 1}^{{N}_{s}} {v}_{k} ln ( \frac{{v}_{k}}{{v}_{k}^{0}} ) \qquad ( 2 )$$

Wherein vₖ⁰ is an initial quantity of the configuration (k), and vₖ is a final calculated quantity of the configuration (k).

Alternatively, the present disclosure also contemplates that using the compressed, super-configuration matrix, the forecasted order may be calculated using the following equation:

$$min {\sum }_{k = 1}^{{N}_{s}} {\sum }_{j = 1}^{{N}_{F}} {\sum }_{i = 1}^{{l}_{j}} {v}_{k , j , i} ln ( \frac{{v}_{kji}}{{v}_{kji}^{0}} ) \qquad ( 3 )$$

Wherein vₖⱼᵢ⁰ is an initial quantity of the feature (i) from the feature family (j) in super-configuration (k); and vₖⱼᵢ is a final calculated quantity of the feature (i) from the feature family (j) in super-configuration (k).

Stated differently, the present disclosure contemplates that for the quantity of the super-configurations (k), the feature families may equate to 100% based upon the following relationship:

$${v}_{k} = {\sum }_{i = 1}^{{l}_{j}} {v}_{k , j , i} \qquad ( 4 )$$

wherein vₖ is the quantity of super configuration (k), and vₖⱼᵢ is a final calculated quantity of the feature (i) from the feature family (j) in super-configuration (k). The present disclosure also contemplates that the total vehicle volume (V) may be calculated using the following equation:

$$V = {\sum }_{k = 1}^{{N}_{s}} {v}_{k} \qquad ( 5 )$$

wherein V is the total vehicle volume, and vₖ is the quantity of super-configuration (k).

The present disclosure further contemplates that the calculated quantity (vₖⱼᵢ) of the feature (i) from the feature family (j) in super-configuration (k) may be required to satisfy the following product structure equalities:

vₖⱼᵢ=0 for sₖⱼᵢ=0,vₖⱼᵢ≧0 for sₖⱼᵢ=1 (6)

wherein vₖⱼᵢ is the calculated quantity of the feature (i) from the feature family (j) in super-configuration (k); and sₖⱼᵢ is the product structure of the feature (i) from the feature family (j) in super-configuration (k).

Lastly, the present disclosure contemplates that the calculated quantity (vₖⱼᵢ) and total vehicle volume (V) may be bound by the feature take (i.e., target mix) rates as shown in the following equality.

$${τ}_{ji}^{l} \leq \frac{1}{V} {\sum }_{k = 1}^{{N}_{s}} {v}_{kji} \leq {τ}_{ji}^{u} \qquad ( 7 )$$

wherein, vₖⱼᵢ is the calculated quantity of the feature (i) from the feature family (j) in super-configuration (k); V is the total vehicle volume; and τⱼᵢ^{l} and τⱼᵢ^{u} are the upper and lower threshold values for the feature take rates.

The present disclosure contemplates that the equation (3) discussed above for the compressed, super-configuration may be unique due to its non-linear, information-preserving formulation, which may minimally adjust the weights of the feature-super-configuration decision variables (vₖⱼᵢ) avoiding unnecessarily setting those variables to zero, while simultaneously satisfying the product structure ({sₖⱼᵢ}), Product Volume (V) and mix forecasts (τⱼᵢ^{l} and τⱼᵢ^{u}). To process the super-configuration and configuration formulations, the present disclosure contemplates that an iterative solution approach may be used to solve the nonlinear objective. For instance, the present disclosure contemplates that a Sequential Quadratic programming algorithm may be employed based upon the application of a Taylor series iterative approximation.

In addition, application 12 may stop the iterative process when the true solution objective converges, within a predetermined relative threshold. Application 12 may also be capable of recognizing potential “division by zero” errors by not allowing the decision variables to become “too small” (i.e., lower than some small threshold value). Inconsistent or wrong forecasts may also be handled by minimal “stretching” (i.e., allowing some solution of a forecasted order (along with diagnostic) even when the user provided bad inputs).

Application 12 may also adjust the wrong targets, including: (1) minimizing the weighted count of stretched targets; (2) minimizing the sum of weighted absolute changes to the targets; (3) minimizing the sum of weighted squares of changes to the targets; and (4) minimizing the weighted information-theoretic metric of the changes to the targets (using the forecasted objective order for the configuration and super-configuration discussed previously).

For instance, application 12 may handle inconsistent forecasts (τⱼᵢ^{l} and τⱼᵢ^{u}) by minimizing the sum of weighted squares of changes to the targets according to the following equation:

$${min}_{{τ}_{ji}^{{l}^{′}} , {τ}_{ji}^{{u}^{′}} , {v}_{kji}} {\sum }_{j = 1}^{{N}_{F}} {\sum }_{i = 1}^{{l}_{j}} [ \frac{{( {τ}_{ji}^{{l}^{′}} - {τ}_{ji}^{l} )}^{2}}{{p}_{ji}^{l} {τ}_{ji}^{l}} + \frac{{( {τ}_{ji}^{{u}^{′}} - {τ}_{ji}^{u} )}^{2}}{{p}_{ji}^{u} {τ}_{ji}^{u}} ] \qquad ( 8 )$$

wherein vₖⱼᵢ is the calculated quantity of the feature (i) from the feature family (j) in super-configuration (k), τⱼᵢ^{l} and τⱼᵢ^{u} are the inconsistent forecast rates, τⱼᵢ^{l′} and τⱼᵢ^{u′} are the calculated (relaxed) consistent forecast rates, pⱼᵢ^{l}, pⱼᵢ^{u} are user preferences towards relaxing the forecasts.

Alternatively, application 12 may handle inconsistent forecasts (τⱼᵢ^{l} and τⱼᵢ^{u}) by minimizing the sum of weighted squares of changes to the targets according to the following equation:

$${min}_{{τ}_{ji}^{{l}^{′}} , {τ}_{ji}^{{u}^{′}} , {v}_{kji}} {\sum }_{j = 1}^{{N}_{F}} {\sum }_{i = 1}^{{l}_{j}} [ \frac{{τ}_{ji}^{{l}^{′}}}{{p}_{ji}^{l}} ln \frac{{τ}_{ji}^{{l}^{′}}}{{τ}_{ji}^{l}} + \frac{{τ}_{ji}^{{u}^{′}}}{{p}_{ji}^{u}} ln \frac{{τ}_{ji}^{{u}^{′}}}{{τ}_{ji}^{u}} ] \qquad ( 9 )$$

wherein vₖⱼᵢ is the calculated quantity of the feature (i) from the feature family (j) in super-configuration (k), τⱼᵢ^{l} and τⱼᵢ^{u} are the inconsistent forecast rates, τⱼᵢ^{l′} and τⱼᵢ^{u′} are the calculated (relaxed) consistent forecast rates, pⱼᵢ^{l}, pⱼᵢ^{u} are user preferences towards relaxing the forecasts.

Additionally, the above non-limiting embodiments of handling inconsistent forecasts may be limited as follows:

$$\begin{matrix}{v}_{k} = {\sum }_{i = 1}^{{l}_{j}} {v}_{kji} for all k , j & ( 10 ) \\ V = {\sum }_{k = 1}^{{N}_{s}} {v}_{k} & ( 11 ) \\ {v}_{kji} \{ \begin{matrix}= 0 & for {s}_{kji} = 0 , \\ \geq 0 & for {s}_{kji} = 1\end{matrix} & ( 12 ) \\ {τ}_{ji}^{{l}^{′}} \leq \frac{1}{V} {\sum }_{k = 1}^{{N}_{s}} {v}_{kji} \leq {τ}_{ji}^{{u}^{′}} & ( 13 ) \\ 0 \leq {τ}_{ji}^{{l}^{′}} \leq {τ}_{ji}^{l} & ( 14 ) \\ {τ}_{ji}^{u} \leq {τ}_{ji}^{{u}^{′}} \leq V & ( 15 )\end{matrix}$$

wherein vₖ is the quantity of super configuration (k); vₖⱼᵢ is the calculated quantity of the feature (i) from the feature family (j) in super-configuration (k); V is the total vehicle volume; sₖⱼᵢ is the product structure of the feature (i) from the feature family (j) in super-configuration (k). τⱼᵢ^{l′} and τⱼᵢ^{u′} are the calculated (relaxed) consistent forecast rates; and, τⱼᵢ^{l} and τⱼᵢ^{u} are the inconsistent forecast rates.

The compressed super-configuration matrix form of the product rule definition may also include no prototypes. Prior art configuration-based methods of propagating product knowledge and demand forecast into forecasts of configuration quantities that didn't incorporate the super-configuration matrix may have required: (1) generation of a randomized, representative sample of configurations, and, (2) fitting configuration weights to feature forecasts.

By incorporating the compressed, super configuration product rules the present disclosure contemplates that there may be no need for computationally costly generation of a randomized representative sample of configurations. The present disclosure further contemplates that enumeration of a complete set of configurations may be computationally infeasible because the number of buildable configurations of many automotive products is prohibitively high (i.e. N_{config}≈billions and trillions).

Use of the compressed super-configuration matrix may be computationally more efficient over prior proprietary heuristic algorithms previously employed. The compressed super-configuration matrix may therefore allow an automotive manufacturer the capability of setting a common set of assumptions and consistent methods for evaluating changes to features during a products development.

The present disclosure contemplates that the output of step 140 for uncompressed configurations may include calculated quantities or those configurations. Moreover, the output of step 140 for compressed configurations using the super-configuration may include calculated quantities or individual features within those super-configurations.

Flow diagram 100 then proceeds to step 150 where application 12 may generate a quantity of all parts necessary to assemble all vehicles in the forecasted order by interacting the quantity of each configuration in the forecasted order with a product bill of material.

With respect to step 150, the present disclosure contemplates that the buildable product space may have already been specified as either an uncompressed or compressed super-configuration matrix. Step 150 also typically may require that the configuration or super-configuration matrix has also been interacted with the forecasted total volume and feature rates and mixes.

The present disclosure contemplates that another input for calculating material requirements may include the “Part-Where-Used” information in which each end-item part may be associated with one or more “Line of Usage” (LOU), which may be specified by a “Usage Condition Code” (UCC) and/or “Quantity”.

Application 12 may have feature super-configuration volumes vₖⱼᵢ with the quantity of feature i from feature family j in super-configuration k. Super-configuration volumes may again be calculated using equation (4) for any family j.

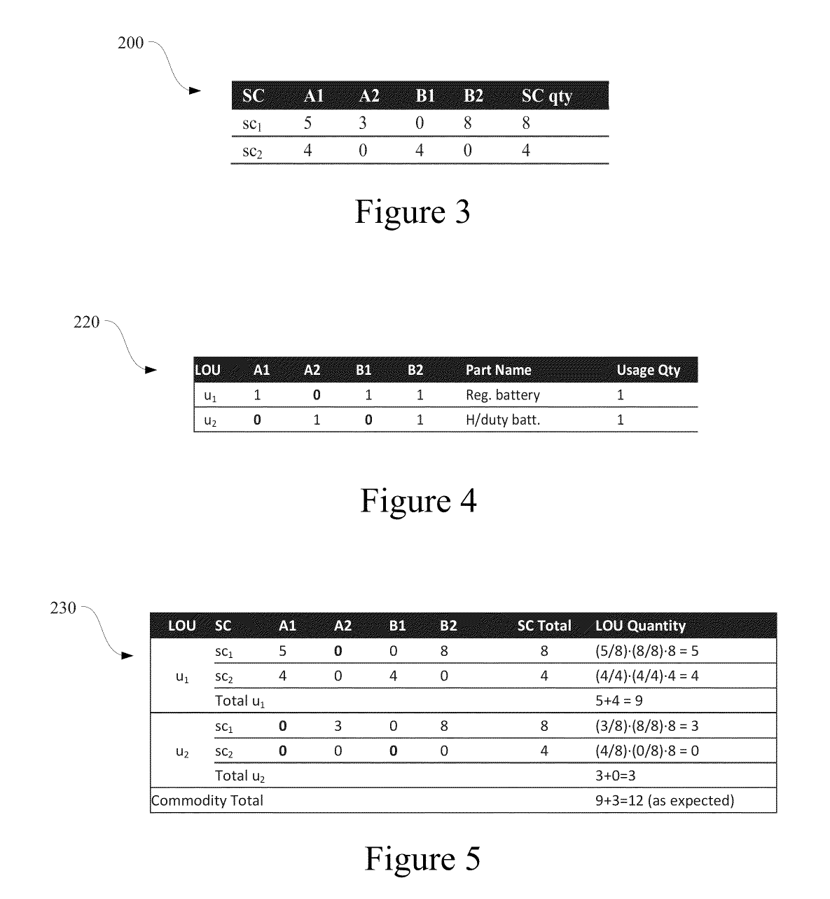

In one non-limiting example, FIG. 3 illustrates a solution 200 that application 12 may have generated in step 140. FIG. 3 illustrates the product defined by two families, ‘A’ and ‘B’, each family having two features, and two super-configurations ‘sc1’ and ‘sc2’. FIG. 3 further illustrates that the feature super-configuration volume v_{1,1,2}=3 may be the quantity of super-configuration k=1 (i.e., of super-configuration “sc1”), family j=1 (i.e., of family ‘A’), feature i=2 within that family (i.e., of feature “A2”). FIG. 3 also illustrates that the super-configuration ‘sc1’ encodes two underlying configurations: “A1” with “B2” in quantity of 5, and “A2” with “B2” in quantity of 3. The super-configuration ‘sc2’ may also encode exactly one underlying configuration: “A1” with “B1” in quantity of 4. The present disclosure also contemplates that in the general case, there may not be a unique mapping of feature super-configuration quantities to the underlying configuration quantities.

The present disclosure contemplates that the h-th “Line of Usage (LOU)” may be represented by a quantity qₕ and a “Usage Condition Code (UCC)” represented by a set of families Fₕ, and corresponding sets of features F_{h,j}.

FIG. 4 illustrates a non-limiting example of a LOU 220. As illustrated, LOU 220 includes a commodity “Batteries” consisting of two parts, “Reg. battery” having line of usage uᵢ, and “H/duty batt.” having line of usage u₂.

It is contemplated that the LOU 220 for uᵢ has UCC=“A1” and usage quantity=1. As such, “Reg. battery” may be installed in quantity of one on any vehicle having feature “A1.” The present disclosure also contemplates that the choice of feature from family ‘B’ may be insignificant. The present disclosure further contemplates that mathematically LOU 220 may be described by h=1; q₁=1; F₁={1}. This may mean that only family ‘A’ is active on this UCC. Also, it is contemplated that F_{1,1}{1} for feature “A1” of family “A.”

It is further contemplated that the LOU 220 for u₂ has UCC=“A2” with “B2” and usage quantity=1. As such, “H/duty batt.” May be installed in quantity of one on any vehicle having both features “A2” and “B2”. Again, the present disclosure contemplates that mathematically, this LOU is described by h=2; q₂=1; F₂={1,2}. This may mean that both families ‘A’ and ‘B’ are active in this UCC. In other words, F_{2,1}={2} for feature “A2” of family ‘A’ and F_{2,2}={2} for feature “B2” of family ‘B’.

The examples shown in FIGS. 3 and 4 illustrate a problem in trying to determine the end-item part volumes of “Reg. battery” and of “H/duty batt.” Application 12 may solve such a problem in step 150 by generating the quantity of all parts necessary to assemble the vehicle product in the forecasted order by interacting the quantity of each configuration in the forecasted order with a product bill of material. For instance, application 12 may assume that the total end-item volume (Vₕ) for the h-th LOU is calculated using the following equation:

$${V}_{h} = {\sum }_{k = 1}^{{N}_{s}} {V}_{hk} \qquad ( 16 )$$

Wherein Nₛ is the total number of super-configurations, and Vₕₖ is the total end-item volume for the h-th LOU in the k-th super-configuration. Application 12 may further calculate the total end-item volume (Vₕₖ) using the following equation:

$${V}_{hk} = {q}_{h} {v}_{k} {\prod }_{{f}_{j} ∈ {F}_{h}} ( \frac{{\sum }_{{f}_{ji} ∈ {F}_{hj}} {v}_{kji}}{{v}_{k}} ) \qquad ( 17 )$$

wherein Vₕₖ is the total end-item volume for the h-th LOU in the k-th super-configuration, qₕ is an end-item part's quantity for an h-th line of usage, Fₕ is the set of families (fⱼ) comprising an h-th line of usage; Fₕⱼ is the set of features comprising an h-th line of usage; vₖⱼᵢ is the quantity of the feature (i) from the feature family (j) in super-configuration (k); vₖ is the quantity of k-th super-configuration. Using these equations, application 12 may propagate the weighted super-configuration features and generate the quantity of all parts necessary to assemble a vehicle product in the forecasted order (i.e., the forecasted part volumes). For instance, FIG. 5 illustrates the forecasted part volumes 230 that may be propagated for the weighted super configurations (i.e., generated by application 12).

If the product definition is inputted as a configuration rather than the compressed super-configurations, the present disclosure further contemplates that the end-item volume (Vₕₖ) may be calculated using the formula:

Vₕₖ=qₕvₖ [symbol] ⱼ₌₁^{N}^{_{F}} [symbol] ᵢ₌₁^{l}^{ⱼ}(bₕⱼᵢ [symbol] bₖⱼᵢ) (18)

wherein qₕ is an end-item part's quantity for an h-th line of usage; vₖ is the quantity of the k-th configuration; bₕⱼᵢ is 1 if h-th line of usage includes the i-th feature from the j-th family; bₖⱼᵢ is 1 if the k-th configuration includes the i-th feature from the j-th family.

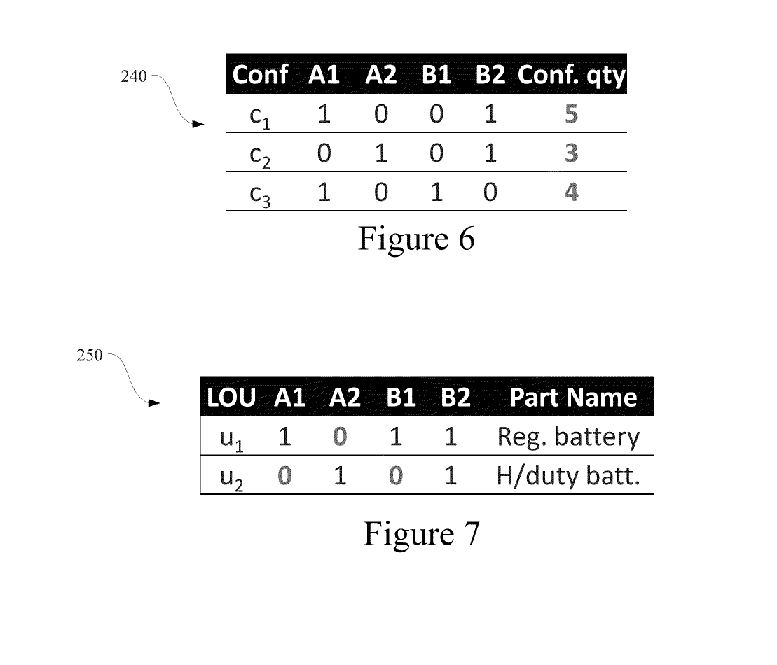

The term [symbol] ⱼ₌₁^{N}^{_{F}} [symbol] ᵢ₌₁^{l}^{ⱼ}(bₕⱼᵢ [symbol] bₖⱼᵢ) may then be evaluated to 1 when the k-th configuration matches the h-th line of usage or the term may be evaluated to 0 when it is determined that there is no match. For instance, FIG. 6 illustrates a set of configurations 240 labeled as c₁, c₂, and c₃ having configuration forecasted quantities of 5, 3, and 4 respectively. FIG. 7 illustrates a set of configuration-to-LOU matches 250 labeled u₁ and u₂. As illustrated the regular battery LOU (u₁) matches configurations 240 c₁ and c₂. The present disclosure therefore contemplates that the total volume of end-item part regular battery's corresponding to the configuration-to-LOU 250 labeled u₁ may have a total configuration quantity of 9 (i.e., 5+4=9). Furthermore, the configuration-to-LOU match 250 labeled u₂ may not be further matched and the configuration quantity for the heavy duty battery may remain 3.

Again, it is contemplated that the present method and system acknowledges that within each given super-configuration, any feature may be combined with any other active feature from a different family. In other words, within each super-configuration, it may be valid to apply a “Rate-on-Rate” methodology. The present method and system may further more accurately account for product structure, by way of treating each super-configuration separately.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A forecasting method comprising:
receiving a product definition representing valid configurations for a product;
receiving a forecast for total sales quantity and feature rates;
receiving a bill of material for the product;
generating a forecasted order by interacting the feature forecast rate with the product definition; and
generating the quantity of all parts necessary to assemble the product by interacting the forecasted order with the bill of material.

2. The method of claim 1, wherein the forecasted order is generated by mapping the feature forecast rate against the product definition, wherein the forecasted order results in assigning nonnegative quantities to all features and configurations of which the product definition is comprised.

3. The method of claim 2 wherein the product definition is represented using a binary super-configuration matrix that includes a bit corresponding to every configurable feature available in the product.

4. The method of claim 3, wherein the binary super-configuration is configured such that each row includes at least one non-zero bit from each family.

5. The method of claim 3, wherein each row in the binary super-configuration matrix includes exactly one non-zero bit from each family.

6. The method of claim 2, wherein the forecasted order is generated such as to avoid as much as practically possible assigning zero quantities to any features and configurations of which the product definition is comprised.

7. The method of claim 4 wherein the forecasted order is calculated based on a ratio of a final quantity of a designated feature from an associated family in a designated super-configuration to a final calculated quantity of the feature from the family in the super-configuration.

8. The method of claim 7 wherein the forecasted order is calculated based on a minimum value of a summation over possible values for the features from associated families for each super-configuration of the final calculated quantity multiplied by a logarithm of the ratio.

9. The method of claim 4, wherein the forecasted order is calculated using the following equation:
$$min {\sum }_{k = 1}^{{N}_{s}} {\sum }_{j = 1}^{{N}_{F}} {\sum }_{i = 1}^{{l}_{j}} {v}_{k , j , i} ln ( \frac{{v}_{kji}}{{v}_{kji}^{0}} )$$
wherein vₖⱼᵢ⁰ is an initial quantity of the feature (i) from the family (j) in super-configuration (k); and vₖⱼᵢ is a final calculated quantity of the feature (i) from the family (j) in super-configuration (k).

10. The method of claim 9, wherein the equation is implemented using Sequential Quadratic Programming.

11. The method of claim 2, wherein the step of generating a forecasted order further involves relaxing the feature forecast rates if the forecasted rates are determined to be inconsistent with respect to the product definition.

12. The method of claim 2, wherein the forecasted order is calculated using the following equation:
$$min {\sum }_{k = 1}^{{N}_{s}} {v}_{k} ln ( \frac{{v}_{k}}{{v}_{k}^{0}} )$$
wherein vₖ⁰ is an initial quantity of the configuration (k), and vₖ is a final calculated quantity of the configuration (k).

13. The method of claim 2, wherein each super-configuration encodes one or more configurations.

14. The method of claim 3, wherein a part volume is generated using the following equation:
$${V}_{h} = {\sum }_{k = 1}^{{N}_{s}} {V}_{hk}$$
wherein Vₕ is the valid part volume for an h-th line of usage, Vₕₖ is the total end-item volume for an h-th line of usage in the k-th super configuration, and Nₛ is the total number of super-configurations.

15. The method of claim 12, wherein the value Vₕₖ is calculated using the following equation:
$${V}_{hk} = {q}_{h} {v}_{k} {\prod }_{{f}_{j} ∈ {F}_{h}} ( \frac{{\sum }_{{f}_{ji} ∈ {F}_{hj}} {v}_{kji}}{{v}_{k}} )$$
wherein qₕ is an end-item part's quantity for an h-th line of usage, Fₕ is the set of families (fⱼ) comprising an h-th line of usage; Fₕⱼ is the set of features comprising an h-th line of usage; vₖⱼᵢ is the quantity of the feature (i) from the feature family (j) in super-configuration (k); vₖ is the quantity of k-th super-configuration.

16. The method of claim 12, wherein the value (Vₕₖ) is calculated using the following equation:
$${V}_{hk} = {q}_{h} {v}_{k} {{}_{j = 1}}^{{N}_{F}} {{}_{i = 1}}^{{l}_{j}} ( {b}_{hji} {b}_{kji} )$$
wherein qₕ is an end-item part's quantity for an h-th line of usage; vₖ is the quantity of the k-th configuration; bₕⱼᵢ is 1 if h-th line of usage includes the i-th feature from the j-th family; bₖⱼᵢ is 1 if the k-th configuration includes the i-th feature from the j-th family.

17. The method of claim 1, wherein the feature forecast rate is an aggregated demand.

18. The method of claim 1, wherein the forecasted order specifies the quantity of each feature in each configuration of the product.

19. A system for forecasting a quantity of parts necessary to assemble all vehicles of a vehicle product, comprising:
a processor configured to:
receive a product definition representing valid configurations for a product, wherein the products include feature families with mutually exclusive features;
receive a forecast for total sales quantity and feature rates, wherein the forecasted rate is an aggregated demand;
receive a bill of material for the product;
generate a forecasted order specifying the quantity of each feature in each configuration of the product by interacting the feature forecast rate with the product definition; and
generate the quantity of all parts necessary to assemble the vehicle product in the forecasted order by interacting the quantity of each configuration in the forecasted order with a product bill of material.

20. A method for forecasting a quantity of parts necessary to assemble all vehicles of a vehicle product, comprising:
receiving a product definition representing valid configurations for a product, wherein the products include feature families with mutually exclusive features;
receiving a forecast for total sales quantity and feature rates, wherein the forecasted rate is an aggregated demand;
receiving a bill of material for the product;
generating a forecasted order specifying the quantity of each feature in each configuration of the product by interacting the feature forecast rate with the product definition; and
generating the quantity of all parts necessary to assemble the vehicle product in the forecasted order by interacting the quantity of each configuration in the forecasted order with a product bill of material.
